(19) United States
(12) Patent Application Publication
(10) Pub. No.: US 2003/0146597 A1
(43) Pub. Date: Aug. 7, 2003

(54) Padded hinge cover for use on wheelchairs

(76) Inventor: Stephen T. Donnelly, Granby, CT (US)

Correspondence Address: DEBORAH A. BASILE, Doherty, Wallace, Pillsbury and Murphy, P.C., One Monarch Place, 19th Floor, 1414 Main Street, Springfield, MA, 01144-1002, US

(21) Appl. No.: 10/071,429

(22) Filed: Feb. 7, 2002

(51) Int. Cl. B62J 25/00

(52) U.S. Cl. 280/291; 280/304.1

(57) ABSTRACT

The present invention is a padded cover that prevents a wheelchair user's legs from coming into contact with a wheelchair footrest units' hinges when the footrest units are removed from the chair. The padded cover mounts onto the frame of a wheelchair directly over the hinges which hold the footrest units to the chair. The padded cover includes a rectangular board which is covered with padding on all of its surfaces. The padded cover is further covered with a durable outer covering. Attached to one side of the padded board are at least one fastening means which fasten the padded board to the tubular frame of the wheelchair directly over the exposed hinges. The padded cover protects the wheelchair user's legs and prevents injury caused by the user's legs coming into contact with the footrest unit hinges.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention involves a padded, protective device for wheelchairs to fit over the footrest assembly of a wheelchair when the footrest is not in use. Specifically, the device is a padded cover that fits directly over the footrest assembly's hinges when the footrest is removed.

Generally, wheelchairs include a plurality of tubular, interconnected frame components that support a seat. Most wheelchairs have four wheels attached to the frame of the chair. These generally include a pair of large, rear wheels and a pair of smaller, front wheels. Additionally, many wheelchairs are equipped with a pair of footrest units which support the legs and feet of the person using the wheelchair. The footrest units are usually mounted onto a wheelchair's frame components at the front of the chair. Many footrest units are attached to the frame components by a hinge. The hinge allows the footrest units to be angled outward or inward to make the chair more comfortable and to facilitate patient access to the wheelchair seat.

Often, footrest units are removable. Typically, a patient who is still mobile will remove the footrests and use the chair for stability. When the footrests are removed, the footrest assembly's metal hinges are exposed. When the hinges are exposed, the wheelchair user often suffers skin tears and bruises on the back of his or her calves, as his or her legs frequently come into contact with the hinges. Additionally, when wheelchair users place blankets over their legs to keep them warm, the blanket will frequently get caught in the wheels of the chair when the footrests are removed. Further, clothing such as dresses, skirts, bathrobes and nightclothes may get caught in the wheels when the footrests have been removed. Accordingly, there exists a need for a padded cover that may be placed directly on top of the footrest assembly's hinges that holds the footrest onto the frame of the wheelchair. There is currently nothing in the art that solves this problem. The present invention fulfills these needs.

### BRIEF SUMMARY OF THE INVENTION

The invention is a padded cover which mounts onto the frame of a wheelchair directly over the hinges which hold the footrest units to the chair. The padded cover includes a padded board against which a patient's legs may rest. The invention also includes a means of fastening the padded surface to the frame of the chair directly on top of the hinge.

In its preferred form, the padded cover comprises a rectangular board which is covered with padding on all of its surfaces. Attached to one side of the padded board are two clamps which fasten the padded board to the tubing of the wheelchair directly over the exposed hinges.

### BRIEF DESCRIPTION OF THE DRAWINGS

FIG. 1 is a perspective view of the padded hinge cover, depicting the individual components thereof.

FIG. 2 is a perspective view of a hinge cover clamp used to fasten the clamp to the wheelchair frame.

FIG. 3 is a perspective view of the cover, illustrating its location with respect to the wheelchair frame and wheel.

### DETAILED DESCRIPTION OF THE INVENTION

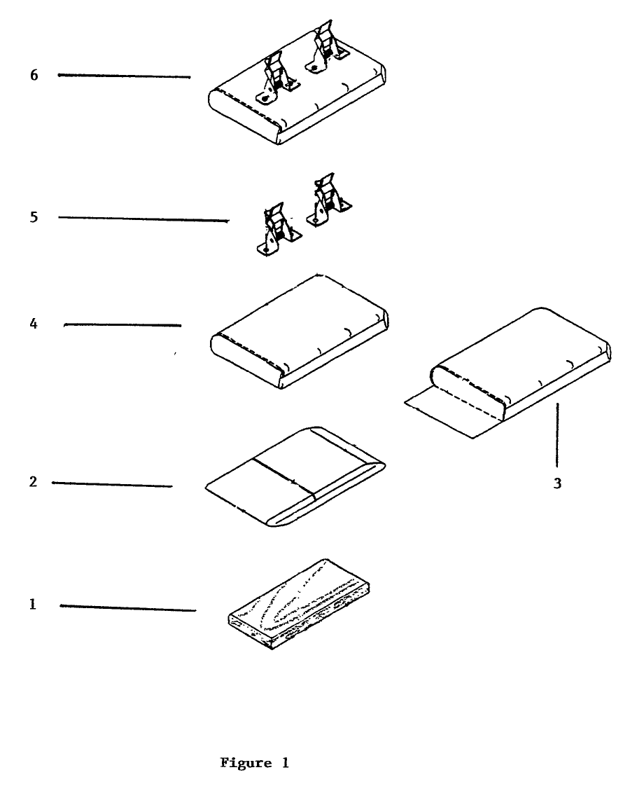

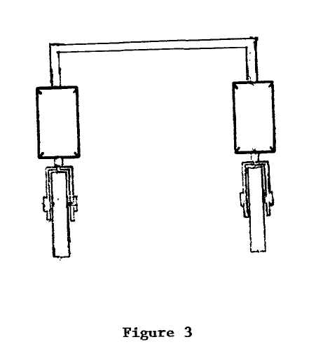

Referring to FIGS. 1, 2 and 3 the preferred embodiment of the present invention is disclosed. FIG. 3 depicts the hinge cover in relation to the front of a wheelchair. The hinge cover 1 attaches to the tubular frame of a wheelchair 2 directly over the footrest unit hinges. The hinge cover is located above the wheels 3 of the chair.

FIG. 1 discloses the various components of the padded cover. A rigid board 1 serves as the base of the cover. Preferably, the base is rectangular in shape, manufactured from wood, is approximately 1″ thick by 2¾″ in width by 5½″ in length, and is rounded on all sides. The base could, however, be manufactured from any rigid material through which screws or similar fasteners may pass. The board is covered with a padding unit 2 which covers the front and back surfaces of the board. The padding unit is preferably made from foam. Preferably, the padding unit is attached to the board by an adhesive such as glue. The board, along with the padding unit, are inserted into the outer covering 3. The outer covering is then closed as depicted in 4. Preferably, the outer covering is made from vinyl or another durable material. These other materials could include leather. At least one fastening means 5 is attached to one surface of the cover 4. Preferably, the fastening means are spring clamps.

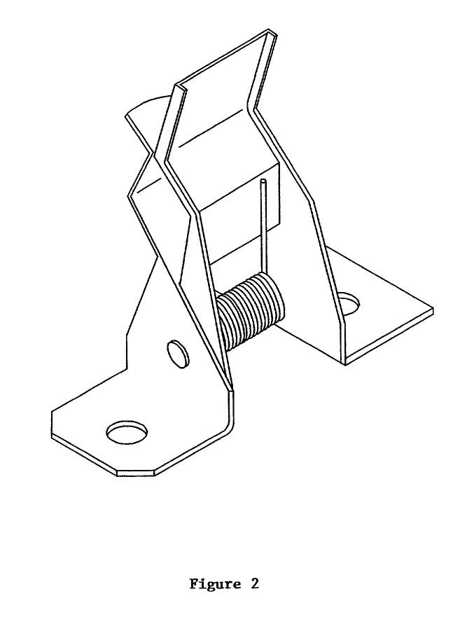

In its preferred configuration, two metal spring actuated clamps are attached to the cover 6. Preferably, the spring actuated clamps are located in the center of the cover in a position to allow the rectangular cover's longer two sides to be vertical and parallel to the tubular leg of the wheelchair. FIG. 2 show preferred configuration of the fastening means.

Referring to FIG. 2, the fastening means in its preferred configuration is a clamp comprised of two spring-accuated curved jaws. The jaws are bent to accept the tubular frame support of a wheelchair. In its preferred configuration, one jaw is slightly longer than the other to facilitate the attachment of the jaws to the tubular chair frame. Each clamp contains two holes through which screws or similar fasteners may pass. In its preferred configuration, the clamp is attached to the board by two screws that run through the clamp holes and into the rigid board passing through both the outer covering and the padding unit. Other fastening means such as non-spring actuated clamps or similar fasteners will also work.

The padded cover is also designed to absorb impact from a patient's leg or an object and return to its original position when the pressure of the impact is relieved. To utilize the padded cover, one may attached the device above the footrest assembly and slide it down over the footrest assembly or attach it directly over the footrest assembly.

As previously mentioned, no prior art solves the problem addressed by the claimed invention. Perry (U.S. Pat. No. 5,604,374) discloses an adjustable arm rest cushion for removable attachment to the arm of a chair. Downing (U.S. Pat. No. 5,700,053) discloses a cushioning and protection apparatus for a chair armrest. A patent to Sullins (U.S. Pat. No. 5,823,574) discloses a writing board that has a padded surface. None of these patents disclose a padded cover that may be removably placed directly on top of a wheelchair footrest assembly's hinges to protect the wheelchair users legs from coming into contact with the footrest assembly when the footrest has been removed.

What is claimed is:

1. A padded cover for removable attachment to the footrest assembly of a wheelchair comprising:
a rigid board having front and back surfaces;
a padding unit covering said front and back surfaces of said rigid board;
an outer surface covering said padded unit;
means for removably securing said rigid board over said footrest assembly; said securing means being attached to said back surface of said rigid board;

2. The padded cover of claim 1 in which said padding unit is made of a foam material.

3. The padded cover of claim 1 in which said rigid board is made of wood.

4. The padded cover of claim 1 in which said outer surface is made of vinyl.

5. The padded cover of claim 1 in which the said outer surface is made of leather.

6. The padded cover of claim 1 in which the securing means is at least one spring actuated clamp.

7. The padded cover of claim 1 in which said rigid board is rectangular in shape.

8. The padded cover of claim 1 in which said padding unit is affixed to said rigid board with glue.

9. A padded cover for removable attachment to the footrest assembly of a wheelchair comprising:
a rectangular rigid board having front and back surfaces;
a foam padding unit covering said front and back surfaces of said board;
an outer surface covering said foam padding unit;
means for removably securing said board over said footrest assembly; said securing means being attached to said back surface of said board; said securing means is at least one spring actuated clamp;

10. The padded cover of claim 9 in which said rectangular rigid board is made of wood.

11. The padded cover of claim 9 in which said outer surface is made of vinyl.

12. The padded cover of claim 9 in which the said outer surface is made of leather.

13. The padded cover of claim 9 in which said padding unit is affixed to said rectangular rigid board with glue.
